(19) United States
(12) Patent Application Publication
(10) Pub. No.: US 2005/0098276 A1
(43) Pub. Date: May 12, 2005

(54) Flexible-screen apparatus

(75) Inventor: Antonino Agliolo Quartalaro, Capo d'Orlando (IT)

Correspondence Address: NIXON & VANDERHYE, PC, 1100 N GLEBE ROAD, 8TH FLOOR, ARLINGTON, VA, 22201-4714, US

(73) Assignee: MEDAL - S.r.l., Castel Guelfo di Bologna (IT)

(21) Appl. No.: 10/969,234

(22) Filed: Oct. 21, 2004

(30) Foreign Application Priority Data
Nov. 6, 2003 (IT) IT-BO2003U000115
Nov. 27, 2003 (IT) IT-BO2003U000120

(51) Int. Cl. E06B 9/17

(52) U.S. Cl. 160/276

(57) ABSTRACT

A flexible-screen apparatus associable with a door or window of a building such as a mosquito-net or curtain, and devices for locking a frame of this apparatus.

The invention relates to a flexible-screen apparatus associable with a door or window of a building such as a mosquito-net or curtain, and devices for locking a frame of this apparatus.

### BACKGROUND OF THE INVENTION

Locking devices are known for rigidly connecting uprights of frames of mosquito-nets to building structures. Each upright is arranged along an abutment of a door or window opening in such a way that it extends between a sill or threshold and a mosquito-net box arranged below a crosspiece of the opening. The locking devices are fitted to one end of each upright, generally at a bottom end of the upright that is positioned on the sill or threshold. The locking devices comprise a plinth by means of which the upright rests on the sill or threshold. From the plinth an appendage protrudes that is configured in such a way as to be accommodated in a groove obtained on one side of the upright intended to be positioned against the vertical abutment of the opening. This appendage is provided with a first concave surface turned upwards and opposite the plinth. It is possible to vary the position of the appendage in relation to the upright by sliding the appendage along a longitudinal axis of the groove. A cursor, which is arranged inside the groove, is associated with the locking devices, said cursor being positionable along the longitudinal axis and provided with a set screw to rigidly fix the cursor itself to the upright. The cursor comprises a second surface that is concave towards the bottom and that is arranged facing the first concave surface. A cam element is provided that is positioned in the groove of the upright and is provided with an elliptic profile and with a through hexagonal hole, or with a square hole or with a slotted seat. Before the upright is positioned on the abutment of the opening, the cursor is fixed in a suitable position inside the groove through the set screw and after the cam element has been inserted into the groove the plinth is connected to the upright by inserting the appendage into the groove. The appendage is inserted by an amount that is such as to interact with the cam element in such a way that the latter comes into contact with the cursor and the cam element is then arranged in a first position in such a way that a major axis of the latter is perpendicular to the longitudinal axis. In this way, the cursor and the appendage are distant by an amount that is equal to the length of a minor axis of the cam element, the total length of the upright connected to the locking device being less than the length of the abutment. In this way, the upright can easily be placed on the abutment of the opening and is initially free to move in the direction of the longitudinal axis. Once the upright has been positioned on the abutment by arranging the plinth on the sill or threshold, the cam element is adjusted that is accessible owing to a slot obtained in a wall of the groove parallel to the abutment. In this way, the cam element is rotated to a second position through a hexagonal key or a screwdriver in such a way that its own major axis is aligned on the longitudinal axis, forcing the cursor that is integral with the upright to move away from the appendage. In this way, a first force is generated that forces the upright to lift up in such a way that one of a top end of the latter is pressed integrally to the box and at the same time a further force is generated that is equal to and opposes the first force that presses the plinth on the sill, thus making the upright integrally connected with the opening.

A drawback of the locking devices disclosed above consists of the fact that it is difficult to modify them geometrically to adapt to the different types of upright because of the high production costs. In fact, if an upright is provided with a groove having a section that is different from the one envisaged the geometric shapes of the cursor, of the cam element and of the appendage have to be modified.

Another drawback of these locking devices consists of the fact that slots have to be provided that are suitably obtained in the uprights to be able to access the cam elements when the uprights are arranged on the shoulders of the door or window openings.

A further drawback of the locking devices disclosed above consists of the fact that an operator in charge of installing the uprights on the opening has difficulty checking that the cam element is correctly arranged in a first position before the uprights are applied to the abutments of the opening. Furthermore, the operator does not have the possibility of checking that the cam element is correctly arranged in a second position after the uprights have been fixed to the opening.

### SUMMARY OF THE INVENTION

An object of the invention is to improve known flexible-screen apparatuses, such as for example mosquito-nets or curtains.

Another object of the invention is to improve locking devices for frames of mosquito-nets.

A further object of the invention is to provide locking devices that can be geometrically modified in an easy manner to adapt to different types of upright without high production costs.

A further other object of the invention is to obtain locking devices that can be connected to profiled elements of uprights without having to subject the profiled elements to further processing.

An other further object of the invention is to provide locking devices that enable an operator to be able to install the uprights on a door or window opening rapidly and safely.

A yet further object is to improve the guide devices for sliding of flexible-screen apparatuses, in particular of the type with a vertical dragging bar.

A yet other further object is to obtain flexible-screen apparatuses wherein the formation of creases or folds in the screen is limited and in which the screen can slide in the guides without difficulty.

A yet further other object of the invention is to produce flexible-screen apparatuses in which the dragging bar and therefore the screen remain within the guides even in the event of an excessive distance between one guide and the other.

Yet a further object is to provide a device that enables significant reducing of the effort required from a user to operate flexible-screen apparatuses such as for example windable mosquito-nets.

Yet a further other object of the invention is to simplify the steps required to use the windable mosquito-nets.

Yet another further object is to provide a braking device for a flexible-screen apparatus, in particular a windable mosquito-net, through which a rewinding stroke of the flexible screen is slowed down, thereby preventing a terminal batten associated with the flexible screen from knocking against a transverse profiled element forming part of the frame of the apparatus.

In a first aspect of the invention, a locking device is provided, in particular a locking device for a mosquito-net upright, comprising a plinth element suitable for interacting between an upright end and a building opening, a cursor element engaging in a groove of said upright and suitable for regulating a preliminary position of said plinth element, a cam element suitable for regulating a final position of said plinth device, wherein said cursor element is provided inside itself with a coupling seat suitable for receiving said cam element.

Owing to this aspect, it is possible to obtain locking devices having a simple structure that can be easily modified with limited production costs in such a way as to enable the locking devices to be connected to uprights with sections of any shape.

Also owing to this aspect, it is possible to obtain locking devices that enable processing to be avoided that are necessary for connecting said locking devices to profiled elements of uprights. In this way, the uprights can be fixed, thereby reducing installation time and costs.

Again owing to this aspect, it is possible to obtain locking devices configured in such a way as to enable an operator to install the uprights on an opening in a simple and safe manner.

In a second aspect of the invention, a guide device is provided that is equipped with a longitudinal cavity having an edge arranged at a certain distance from an intended support plane, said longitudinal cavity being suitable for guiding the sliding of a flexible-screen element arranged to be coupled with a building opening, wherein a surface element is provided that progressively declines towards said intended support surface moving away from said longitudinal cavity.

In a third aspect of the invention, a guide device is provided that is equipped with a longitudinal cavity having an edge arranged at a certain distance from an intended support surface, said longitudinal cavity being suitable for guiding the sliding of a flexible-screen element arranged to be coupled with a building opening, wherein said longitudinal cavity comprises base wall elements arranged substantially in contact with said intended support plane.

Owing to the second and third aspect of the invention, the guide devices do not constitute an obstacle to the movement of a person through the threshold, although they enable the person to move easily without incurring the danger of tripping, and the risk of accidents is thus significantly reduced.

In one embodiment, the surface element comprises at least one convex surface.

In another embodiment, the surface element comprises at least one flat surface joined to a convex surface.

In a fourth aspect of the invention, a guide device is provided that is suitable for guiding the sliding of a flexible-screen element, wherein a tensioning device is furthermore arranged for tensioning said flexible-screen elements when said flexible-screen element interacts with said guide device.

Owing to the tensioning device, a flexible-screen apparatus can be obtained, for example a mosquito-net, in which the formation of creases or folds in the flexible-screen element, i.e. the net, is prevented in such a way that the latter can easily slide in the guide devices.

In one embodiment, the tensioning device is configured in such a way as to push an edge of the flexible-screen elements inside the longitudinal cavity of the guide devices.

In another embodiment, the tensioning device is arranged in grooves obtained in the longitudinal cavity of the guide devices.

In a further embodiment, the tensioning device comprises a first tensioning device and a second tensioning device facing one another and intended to be arranged on sides opposite the flexible-screen element.

In another further embodiment, the first tensioning device and the second tensioning device comprise brush elements.

In another further yet further embodiment, the guide device, made according to the second and/or third and/or fourth aspect of the present invention, and/or in one of the respective embodiments, is arranged to guide the sliding of a flexible mosquito-net.

In a fifth aspect of the invention, an apparatus is provided, comprising a bar device suitable for dragging a flexible-screen element of a building opening and having ends that can be engaged in opposed guides arranged at a certain mutual distance, wherein one of said ends is provided with a distance compensating element configured in such a way as to enable the length of said bar device to be varied according to said distance.

Owing to the compensating element, it is possible to obtain a mosquito-net in which the flexible screen, namely the net, cannot easily leave the guide devices during use even if the guides are at a different distance from the theoretically envisaged one.

In an embodiment, the distance compensating element comprises a projecting element that is slidable in the bar device between an inserted position, in which the projecting element does not substantially protrude from the bar device, and an extracted position, in which the projecting element protrudes by a certain amount from the end of the bar device that is provided with the compensating element.

In another embodiment, the distance compensating element comprises a fixing element arranged to fix the position of the projecting element in relation to the end of the bar device that is equipped with the compensating element.

In another further embodiment, the projecting element comprises a sliding block element that is slidable in a notch obtained in the bar device.

In a further embodiment, a locking element is provided that is arranged to fix the flexible-screen element to the bar device.

In another further embodiment, the locking element is provided in the grippable end of the bar device.

In a yet further embodiment, the locking element comprises a jaws element arranged to tighten an edge portion of the flexible-screen element.

In another yet further embodiment, the jaws element comprises a first jaw provided with teeth and a second jaw provided with holes, said holes being arranged to interact with the teeth to hold a part of the edge portion, interposed between the teeth and the holes.

In a further yet further embodiment, a guide elements is provided to guide the sliding of the flexible-screen element.

In another yet further further embodiment, small wheels are provided that are arranged to rotate on the guide elements.

In another further yet further embodiment the guide element is made as provided in the second and/or third and/or fourth aspect of the present invention, and/or according to one of the corresponding embodiments.

In a sixth aspect of the invention, a device is provided that is arranged for being associated with a frame for a windable screen element and configured in such a way as to enable a movable portion of said frame to move away from a fixed portion of said frame.

Owing to this aspect of the invention it is possible, in a windable mosquito-net frame, to release the movable bar from the upright by acting on a suitable device. This enables the user to make a certain effort only to shift the movable bar to the opposite upright and thus unwind the net.

In an embodiment, the device comprises a first inclined plane element arranged to be associated with the movable portion of the frame.

In another embodiment, the first inclined plane element is obtained in a wedge element that is integral with the movable portion.

In a further embodiment, a second inclined plane elements is furthermore provided that is arranged to be associated with the fixed portion of the frame and to interact with the first inclined plane element.

In a further other embodiment, the first inclined plane element is shiftable in a certain direction so as to slide on the second inclined plane element.

In another further embodiment, the first inclined plane element is shiftable owing to a cursor element associated with the mobile portion.

In another yet further embodiment, the cursor element can slide in a groove obtained in a margin of the movable portion of the frame.

In another yet further embodiment, the cursor element is equipped with an elastic element arranged to keep said first inclined plane element and the second inclined plane element in a closed position, in which the movable portion and the fixed portion mate with each other.

In a yet further further embodiment, the second inclined plane element is obtained in a body element arranged to be inserted in a seat obtained in the fixed portion.

In another further yet further embodiment, the first inclined plane element defines an angle that is smaller than 90° in relation to a base portion of the wedge element.

Also in another embodiment, the second inclined plane element defines a further angle having a size that is equal to the size of the above-mentioned angle smaller than 90° in relation to a flat face of the body element.

Also in a further embodiment, the wedge element is associated with a face of the mobile portion turned, when in use, to a user.

Also in another embodiment, the movable portion comprises a movable bar of the frame.

Also in another further embodiment, the fixed portion comprises an upright of the frame.

Also in another further embodiment, the windable screen element comprises a windable mosquito-net.

In a seventh aspect of the invention a braking device is provided for an apparatus equipped with a flexible-screen element comprising two side guides and a transverse profiled element within which a roller is present that is forced to rotate by a spring, on which roller said flexible-screen element is wound, said flexible-screen element having a protruding end fixed on a batten and furthermore comprising a stem on which a flat washer is fitted that is shapingly coupled with an inner surface of said roller, said flat washer having at least one face in contact with a disc in material having a high surface-friction coefficient, said disc being rigidly coupled with a fixed part of said device.

In an embodiment of the device, the flat washer is comprised between two discs in material having a high surface-friction coefficient.

In another embodiment, the discs have their faces opposite the face resting on the flat washer resting on a rosette washer fixed to the body of the device.

In a further embodiment, the discs are forced against the face of the respective flat washer by means of springs with an axial action, said springs being concentric to the stem and fitted thereupon.

In another further embodiment, the end of the stem, which faces the inside of the profiled element, is threaded, a threaded nut being engaged there so as to compress the springs with an axial action, thereby increasing the friction between the movable flat washer and the fixed discs.

In another yet further embodiment, in the flat washer three grooves are obtained that are arranged to accommodate respective reinforcements present on the internal surface of the roller, thereby making the flat washer and the roller integral, when the braking device has been fitted.

In another yet further embodiment, each of the discs is made of a material such as leather.

In another yet further further embodiment, a braking device is provided as disclosed in the seventh aspect of the present invention and/or in one of the respective embodiments.

### BRIEF DESCRIPTION OF THE DRAWINGS

The invention can be better understood and actuated with reference to the attached drawings that illustrate an embodiment by way of non-limitative example, in which:

FIG. 1 is an exploded and fragmentary view of locking devices for flexible-screen apparatuses, such as for example mosquito-nets;

FIG. 2 is a fragmentary view of the locking devices in FIG. 1 taken from a first side suitable for facing an abutment of a door or window opening;

FIG. 3 is a fragmentary view taken from a second side opposite the first side, which shows the locking devices in FIG. 1 in a first configuration;

FIG. 4 is a fragmentary view taken from a second side opposite the first side, which shows the locking devices in FIG. 1 in a second configuration;

FIG. 5 is a perspective fragmentary front view from above of screen elements;

FIG. 6 is a side view according to direction II of the screen elements of FIG. 1;

FIG. 7 is a perspective view of a detail of the screen elements in FIG. 1, illustrating a terminal locking element when fitted in the screen elements;

FIG. 8 is a view like the one in FIG. 3 illustrating the terminal locking element during an assembly phase thereof;

FIG. 9 is a fragmentary perspective rear and plan view of a detail of the screen elements in FIG. 1 illustrating compensating elements in a retracted configuration;

FIG. 10 is a view like the one in FIG. 5 in which the compensating elements are in an advanced configuration.

FIG. 11 is a front view showing a prior-art mosquito-net to which a device is applied to release a movable bar;

FIG. 12 is an enlarged, fragmentary and incomplete perspective view showing first inclined plane elements of the device in FIG. 1;

FIG. 13 is a further enlarged, fragmentary and incomplete perspective view showing first inclined plane elements of the device in FIG. 2;

FIG. 14 is an enlarged, fragmentary and incomplete perspective view of second inclined plane elements of the device in FIG. 1;

FIG. 15 is an incomplete, fragmentary, and schematic side view showing the reciprocal position of the first inclined plane elements and of the second inclined plane elements in the device in FIG. 1 in a closed configuration;

FIG. 16 is a schematic, fragmentary and incomplete side view of the device in FIG. 1 in a phase preceding operation;

FIG. 17 is a schematic, fragmentary and incomplete side view of the device in FIG. 1 in an operation phase;

FIG. 18 is a partially sectioned longitudinal view showing a braking device for flexible-screen apparatuses, such as for example windable mosquito-nets, aligned on respective profiled element, roller and flexible-screen element;

FIG. 19 is a longitudinal view of a braking device like the one in FIG. 1, shown in a configuration in which the springs are compressed;

FIG. 20 is a front view of a braking device like the one in FIG. 18;

FIG. 21 is a front view of a transverse profiled element associated with respective roller, flexible-screen element and batten;

FIG. 22 is an exploded perspective view showing a reciprocal arrangement of constructional elements that are comprised in the braking device of FIG. 1.

### DETAILED DESCRIPTION OF THE INVENTION

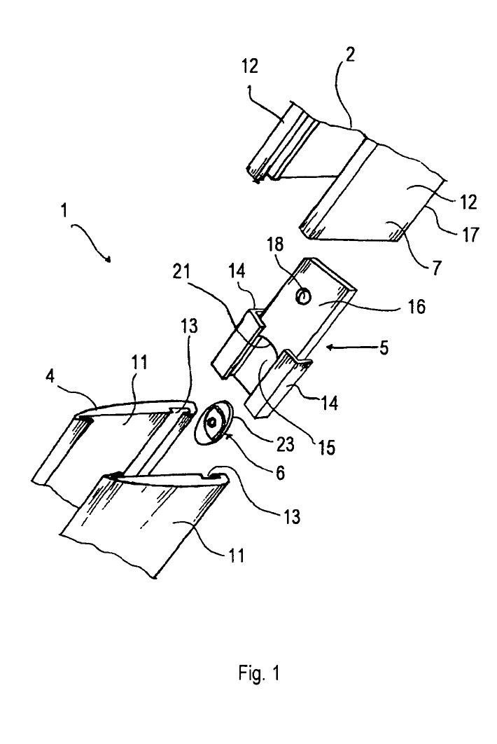

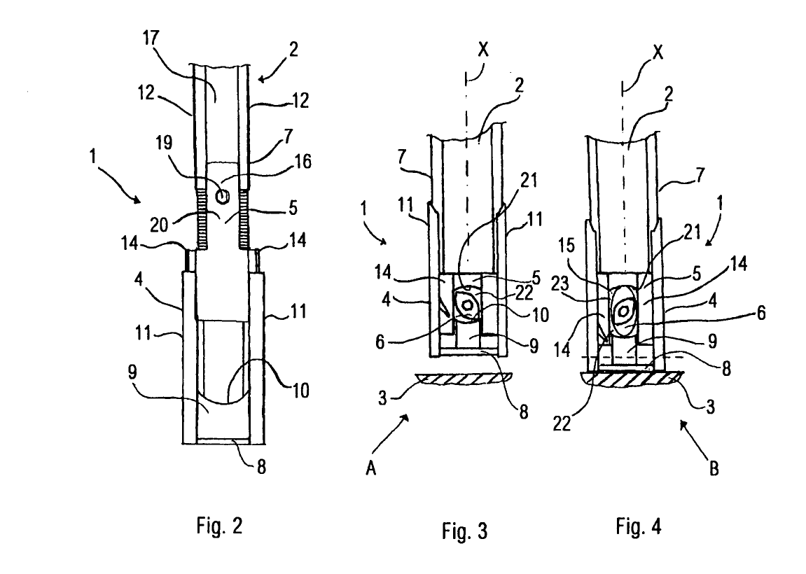

With reference to FIGS. 1 to 4, there is shown a locking device 1 suitable for locking a mosquito-net upright 2 arranged vertically in a door or window opening. The locking device 1 comprises a plinth element 4 that has first side walls 11 and is provided at the bottom with a support base 8 through which the upright 2 is rested on a sill 3 of a window or on a threshold of a door. The plinth element 4 is configured in such a way as to house inside itself a bottom end 7 of an upright in such a way that between the first side walls 11 second side walls 12 of said upright 2 are slidably accommodated. The plinth element 4 is provided with an appendage 9 that protrudes from the support base 8 towards the upright end 7 and which provides at its top a first concave surface 10 turned to the upright end 7. On the first side walls 11, at the inside of the plinth element 4, coupling grooves 13 are obtained arranged along a longitudinal axis X of the upright and suitable for accommodating in a sliding manner side portions 14 of a cursor element 5 that is suitable for regulating the position of the locking device 1 on the upright 2. The cursor element 5 is provided with a coupling portion 16, which is substantially rectangle-shaped and configured in such a way as to be able to be inserted into a groove 17 (shown more closely in FIG. 2) of the upright 2, said groove 17 being arranged along the longitudinal axis X. On a surface 20 of the coupling portion 16 a threaded through hole 18 is obtained that houses a set screw 19. The set screw 19 is configured in such a way as not to substantially protrude from said surface 20 and enables the coupling portion 16 to be fixed in the groove 17 in such a way that the cursor element 5 is rigidly constrained to the upright 2. Between the side portions 14 and the coupling portion 16 of the cursor element 5 a coupling seat 15 is obtained that is suitable for housing a cam element 6 having a coupling profile 23 whose shape is substantially elliptic and suitable for receiving part of the appendage 9. The coupling seat 15 is delimited at the coupling portion 16 by a second concave surface 21 that, once the locking device 1 has been connected to the upright 2, faces the first concave surface 10, contributing to define a variable cavity 22 inside which the cam element 6 is located. When applying the upright 2 to the abutment of the door or window opening is desired, the cursor element 5 is first fixed in the groove 17 of the upright 2 in such a way that the coupling seat 15 is arranged on a side of the cursor element 5 opposite a side in contact with the abutment. The coupling portion 16 of the cursor element 5 is inserted inside the groove 17 by a given amount according to the length of the abutment of the opening and is integrally fixed by acting on the set screw 19. After inserting the cam element 6 into the coupling seat 15 and after connecting the plinth element 4 to the upright end 7, the plinth element 4 is pushed against the cursor element 5 in such a way that the major axis of the cam element 6 is arranged perpendicularly to the longitudinal axis X. In this configuration, the plinth element 4 takes on a preliminary position A that enables the upright 2 to be easily placed in the opening. Subsequently, through a hexagonal key, the cam element 6 can be rotated to make its coupling profile 23 interact with the first concave surface 10 and the second concave surface 21, forcing the upright 2 to partially protrude outside the plinth element 4 towards a crosspiece of the opening placed above. When the major axis of the cam element 6 is aligned on the longitudinal axis X, the plinth element is arranged in a final position B and the upright 2 is rigidly constrained between the crosspiece and the rabbet or threshold of the opening. As the cam element 6 is always completely visible, it is possible to ensure that the latter is correctly positioned in such a way that the upright 2 is rigidly fixed to the building opening. If it is desired to dismantle the upright 2, it will suffice to repeat in reverse order the installation phases disclosed above.

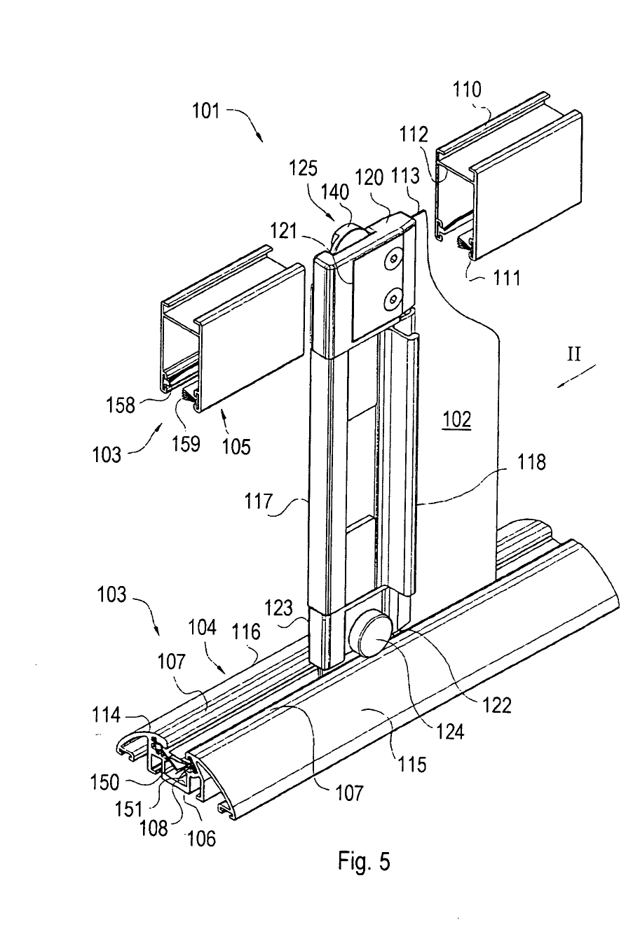

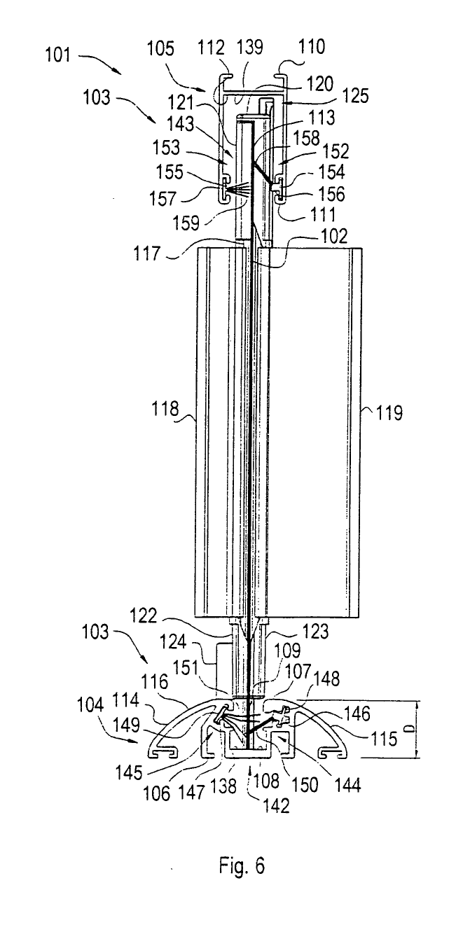

FIGS. 5 and 6 show an apparatus comprising a screen element, in particular a mosquito-net 101, for example of the type that is slidable in a direction substantially parallel to a sill of a window or a threshold of a French window, comprising a screen 102, for example a flexible net, which is slidable in a guide device 103 comprising a guide 104, intended to be associated with the sill or the threshold, and a further guide 105, intended to be associated with a top area of an opening defined by the window or French window, for example arranged below a crosspiece of the opening, said top area facing the sill or the threshold. The guide 104 and the further guide 105 are obtained from profiled elements, in particular in aluminium, having a cross-section provided with grooves. The guide 104 comprises a face 106 that can be coupled with the sill or threshold, a part 107 facing the screen 102 and comprising a cavity 108 substantially arranged in the centre of a cross-section of the guide 104 and suitable for accommodating an edge 109 of the screen 102 that is slidable in the guide 104. The further guide 105 comprises, similarly to the guide 104, a further face 110 that can be coupled with the top area of the crosspiece of the window or French window, a further part 111 facing the screen 102 and comprising a further cavity 112 arranged substantially in the centre of a cross-section of the further guide 105 and suitable for accommodating a further edge 113 of the screen 102 that is slidable in the further guide 105 and situated in a region of the screen 102 opposite that of the edge 109. When the guide 105 is assembled on a threshold, it is particularly important for the guide 105 not to obstruct the passage of a person or not to constitute an obstacle against which a person may knock or stumble. The guide 104 comprises a profile 114 that is accessible for the user and that is provided with rounded surfaces and is furthermore shaped in such a manner that it can be walked on. In fact, the distance D between the part 107 and the face 106 is selected in such a way as to be less than the average distance between the tip of the foot of a person and the ground when the person whilst walking has his or her heel resting on the ground and the tip of his or her foot raised. Furthermore, the profile 114 comprises a convex surface 115, arranged at a side of the profiled element in relation to the cavity 108 and a further convex surface 116 arranged at a side opposite the above-mentioned side in relation to the cavity 108. The convex surface 115 and the further convex surface 116 link the part 107 and the face 106 together, the part 107 being substantially parallel to the face 106. The guide 104, which in use remains exposed to contact with a person, is therefore devoid of edges or summits and the risk that a person will be scratched or injured is rather limited. The mosquito-net 101 furthermore comprises a dragging bar 17 to which the screen 102 is hooked and which supports an internal handle 118 intended to be turned to the inside of a room, and an external handle 119 intended to be arranged outside such a room. A user may grasp the internal handle 118 or the external handle 119 to open or close the opening in which the mosquito-net 101 is fitted from the inside or outside of the room. At an end 122 of the dragging bar 117 a first locking member 123 is comprised, and at a further end 120 of the dragging bar 117 a second locking member 121 is comprised. These locking members 121 and 123 enable the screen 102 to be locked to fix it to the dragging bar 117, as disclosed below.

The second locking member 121 is furthermore arranged to interact with walls inside the further cavity 112 and the first locking member 123 is arranged to interact with walls inside the cavity 108 in such a way as to enable the screen 102 to extend between the guide 104 and the further guide 105 and to run in the cavity 108 and the further cavity 112. On a side of the end 122 the dragging bar 117 is partially supported by a small wheel 124 rotatably fixed to the end 122 and which can roll along the part 107 of the guide 104. Owing to the small wheel 124, the screen 102 can easily slide inside the cavity 108. In an embodiment that is not shown, the small wheel 124 can be arranged on an opposite side of the end 122. In a further embodiment, which is also not shown, a plurality of small wheels can be provided on the same side or be distributed on opposite sides of the end 122. At the further end 120 a distance compensating element 125 is connected that interacts with the guide device 103 to compensate the distance between the guide 104 and the further guide 105, in particular between a base wall 138 of the cavity 108 and a further base wall 139 of the further cavity 112, when the guide 104 and the further guide 105 are respectively associated with the sill or threshold and with the top crosspiece of the opening of the window or French window. The distance compensating element 125 is configured in such a way as to enable the length of the dragging bar 117 to be varied according to the distance between the base wall 138 and the further base wall 139.

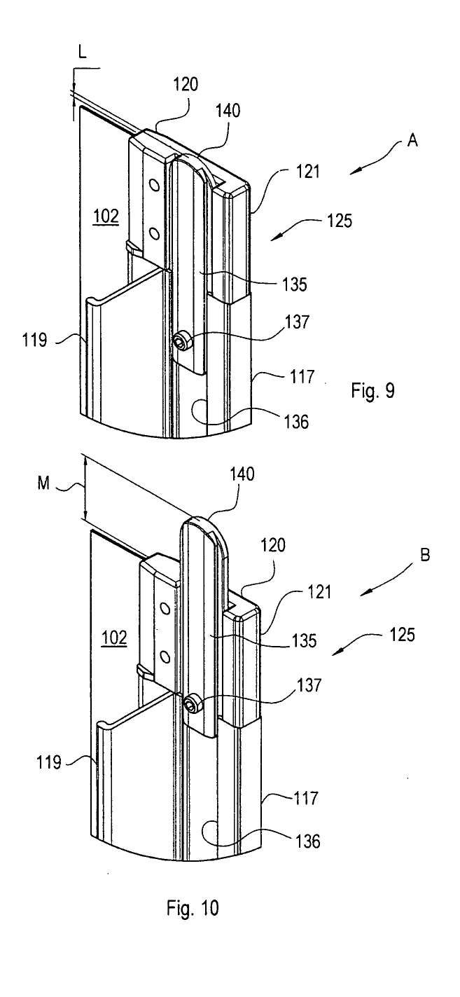

In the embodiment in FIGS. 9 and 10 the distance compensating element 125 comprises a sliding block 135 that is slidable in a straight notch 136. The straight notch 136 is obtained in a face of the further end 120 and furthermore extends in the dragging bar 117. The position of the sliding block 135 in the straight notch 136 is adjustable and can be fixed by a screw 137 between two end positions comprising an inserted position A, shown in FIG. 9, in which an end region 140 of the sliding block 135 protrudes from the straight notch 136 towards the further base wall 139 of the further guide 105 by a distance L, and an extracted position B, shown in FIG. 10 in which the end region 140 of the sliding block 135 protrudes from the straight notch 136 to the further base wall 139 by a distance M, L being less than M. Owing to manufacturing defects of the opening of the window or French window, after assembly of the mosquito-net 101, the distance between the base wall 138 of the guide 104 and the further base wall 139 of the further guide 105 may result greater than a preset distance for correct operation of the mosquito-net 101. In this case, the dragging bar 117, and therefore the screen 102, could leave the cavity 108 and the further cavity 112 during use. Furthermore, when a user grasps the internal handle 118 or the external handle 119 to actuate the mosquito-net 101, he or she may accidentally lift up the dragging bar 117 thereby removing the small wheel 124 from contact with the part 107, by removing the screen 102 from the guide 104 and thus damaging the mosquito-net 101.

The distance compensating element 125 enables the distance between the further end 120 and the further base wall 13 of the further guide 105 to be reduced by a amount that is the same as the length of the portion of the sliding block 135 that protrudes from the straight notch 136 once the position of the sliding block 135 inside the straight notch 136 has been adjusted. In this way, the dragging bar 117 and the screen 102 remain inside the guides 104 and 105. In fact, the dragging bar 117 may be lifted by a certain amount to the point in which the terminal region 140 does not come into contact with the further base wall 139, this amount not being sufficient to enable the dragging bar 117 to leave the guides 104 and 105.

The distance compensating element 125 furthermore enables any manufacturing or assembly faults of the guides 104 and 105 to be compensated. In embodiments that are not shown distance compensating elements are provided that are also associated with the end 122. These compensating elements may be structurally similar to that disclosed above or may be different.

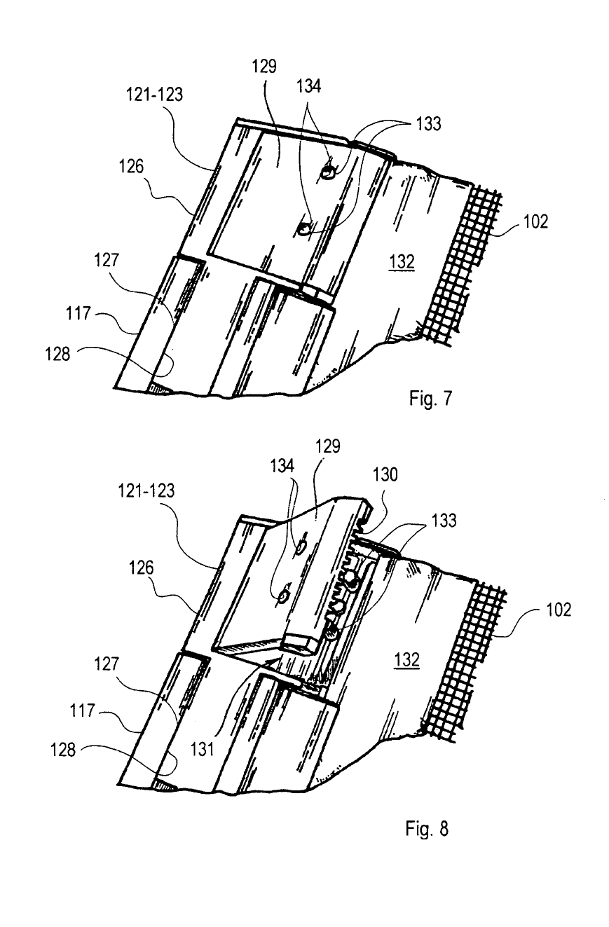

The mosquito-net 101 furthermore comprises a tensioning device 141 arranged for tensioning the screen 102 when the screen 102 interacts with the guide device 103. The tensioning device 141 comprises a pair of brushes 142 associated with the guide 104 and a further pair of brushes 143 associated with the further guide 105. With reference to FIG. 6, the pair of brushes 142 comprises a first brush 144 and a second brush 145 housed respectively in a first groove 146 and in a second groove 147 obtained in the profiled element of the guide 104 in zones communicating with, next to and on opposite parts of the cavity 108, in such a way that the edge 109 of the screen 102 is interposed between the first brush 144 and the second brush 145. The first brush 144 and the second brush 145 each comprise a first base 148 and a second base 149 accommodated respectively in the first groove 146 and in the second groove 147 and on which first bristles 150 and second bristles 151 are fitted that protrude from the respective bases 148 and 149 to the edge 109. The first bristles 150 and the second bristles 151 may be of polymeric or elastomeric material and the first bristles 150 are stiffer than the second bristles 151. The first bristles 150 protrude from the first base 148 substantially parallel to one another in a direction intersecting the plane defined by the screen 102 and make the edge 109 approach the base wall 138 of the cavity 108. The second bristles 151 fan out from the second base 149 and cooperate to uniformly distributing on the edge 109 the pressure exerted on the screen 102 by the first bristles 150 and to counteract this pressure. Similarly, the further pair of brushes 143 comprises a third brush 152 and a fourth brush 145 respectively housed in a third groove 154 and in a fourth groove 155 obtained in the profiled element of the further guide 105 on sides opposite the further cavity 112 and alongside and communicating with the cavity 112, in such a way that the further edge 113 of the screen 102 is interposed between the third brush 152 and the fourth brush 155. The third brush 152 and the fourth brush 155 each comprises a third base 156 and a fourth base 157 respectively housed in the third groove 154 and in the fourth groove 155 and in which third bristles 158 and fourth bristles 159 are respectively fitted that protrude from the respective third base 156 and fourth base 157 to the further edge 113. The third bristles 158 are similarly configured to the first bristles 150 and are stiffer than the fourth bristles 159. The third bristles 158 protrude from the third base 156 substantially parallel to one another in a direction intersecting the plane defined by the screen 102 and make the further edge 113 approach the further base wall 139 of the further cavity 112. The fourth bristles 159 fan out from the fourth base 149 and help to uniformly distribute the pressure exerted on the screen 102 by the third brushes 158 and to counteract this pressure. As the pair of brushes 142 acts on the edge 109 to push it towards the inside of the cavity 8 and the further pair of brushes 143 acts on the further edge 113 to push it inside the further cavity 112, the screen 102 is tensioned by the action of the pair of brushes 142 and by the further pair of brushes 143, and the formation of creases or folds on the sliding edges of the screen 102 is thus avoided. Furthermore, the pair of brushes 142 and the further pair of brushes 143 contribute to keeping the screen 102 inside the guide 104 and the further guide 105. As shown in FIGS. 7 and 8, both the first locking member 123 and the second locking member 123 comprise a body 126 provided with a protruding element 127 arranged to couple with a furrow 128 obtained in the dragging bar 117 to fix the body 126 to the sliding bar 117. The body 126 is provided with a notch 131 arranged to house an edge zone 132 of the screen 102 and provided with pins 133 that protrude from the bottom of the notch 131 for a certain length. A fin 129, hinged on one side of the body 126 and comprising on a side opposite that side an indented edge 130, acts as a closing element of the notch 131 and is provided with two holes 134 that are coupled with the pins 133 when the fin 129 is in a closed position of the notch 131. As shown in FIG. 8, to fix the screen 102 to the dragging bar 117, the fin 129 is arranged in an open position of the notch 131 and the edge zone 132 is taken inside the notch 131 in such a way that it covers the pins 133. At this point, the fin 129 is taken to the closed position of the notch 131 so that the holes 134 interact with the pins 133 and a portion of the edge zone 132 is pressed against walls of the holes 134 by the pins 133. The indented edge 130 cooperates to increasing the friction between the body 126 and the edge zone of the screen 132, preventing the screen 102 from being able to come out from the notch 131.

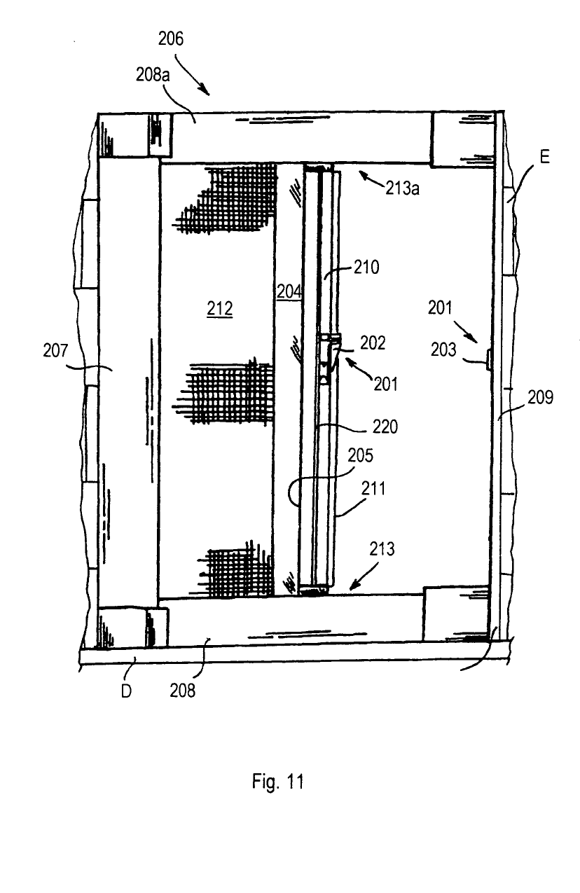

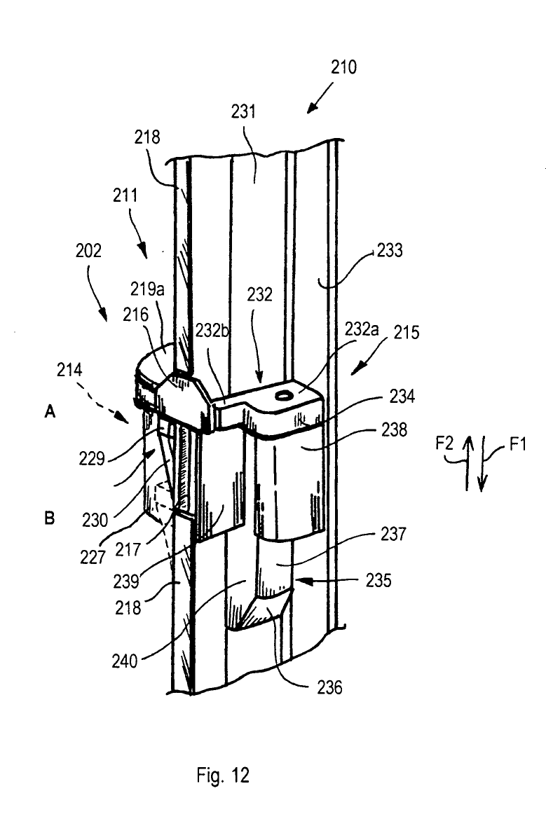

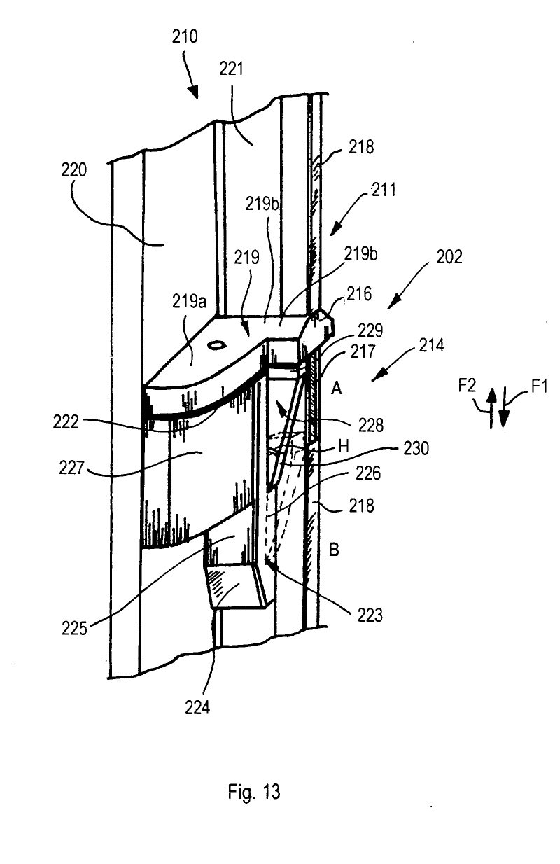

With reference to FIG. 11, an unlocking device 201 is applied to a frame 206 of a prior-art windable mosquito-net 212 associated with a window that is not shown of a building E. The frame 206 comprises a first upright 207 and a second upright 209 that are integral with a first crosspiece 208 and with a second crosspiece 208a, which are parallel to each other and at right angles to the first upright 207 and to the second upright 209. The first crosspiece 208 rests on a sill D, opposite which the second crosspiece 208a is positioned. A movable bar 210 slidingly engages its own end portions, which are not shown, in longitudinal guides 213, 213a obtained respectively in the first crosspiece 208 and in the second crosspiece 208a. On a first margin 205 of the movable bar 210, opposite the second upright 209, there is constrained a corresponding first edge 204 of a mosquito-net 212 that is windable around a shaft that is not shown that is contained inside the first upright 207. The unlocking device 201 comprises a first inclined plane element 202 associated with the movable bar 210, and a second inclined plane element 203 that is associated with the second upright 209. With reference to FIGS. 12 and 13, the first inclined plane element 202 bridges a second margin 211 of the movable bar 210, parallel to the first margin 205 and opposite the first upright 207.

This bridge structure enables the device 201 to be operated from opposite sides of the windable mosquito-net 212, which can be particularly appreciated when the mosquito-net 212 is installed in a French window.

The second margin 211 is almost completely clad by a magnet 218 that extends longitudinally. In the first inclined plane surface 202 a first portion 214 and a second portion 215 are identifiable that are made integral by means of a hexagonal connecting plate 216 and are respectively adjacent to a first face 221 and to a second face 231 of the movable bar 210 that are opposite each another. In use, the first portion 214 is turned to the inside of the window and therefore to a user, who is not shown, whereas the second portion 215 is turned to the outside of the window. On a face that is not shown of the connecting plate 216 a cursor element starts that is not shown that can slide inside a race 217 obtained along a portion of the second margin 211 at which the magnet 218 is interrupted.

The first portion 214 comprises a first support element 219 consisting of a greater branch 129a and a lesser branch 219b. The approximately triangle-shaped greater branch 219a is integral with a longitudinal projection 220 that protrudes from the first face 221 of the movable bar 210 at right angles to the latter and furthermore runs parallel to it. The lesser branch 219b, which is substantially rectangle-shaped, is at right angles to the greater branch 219a and is integral with the first face 221. An end portion of the lesser branch 219a is integral with the connecting plate 216. The first support element 219 has a free margin 222 that first runs straight near the connecting plate 216 and then becomes convex, terminating near the longitudinal projection 220. A second support element 223, that is substantially parallelepiped-shaped, is simultaneously associated with the first support element 219, with the first face 221 of the movable crosspiece 210 and with the longitudinal projection 220. The second support element 223 has a chamfered first end face 224 and a second end face that is not shown and is opposite the first end face 224, which is integral with the first support element 219. A first side face 225 of the second support element 223, opposite the first face 221 of the movable bar 210 is partially occupied by a third support element 227 having a cross-section shaped like the greater branch 219a of the first support element 219. Two further faces that are not shown of the third support element 227 are respectively integral with the first support element 219 and the longitudinal projection 220. A wedge element 228 is integral with the second support element 223 at a second side face 226 of the latter next to the first side face 225 and opposite the first face 221 of the movable bar 210. The wedge element 228 has a triangular longitudinal section and is associated with the lesser branch 219b of the first support element 219 by means of a parallelepiped portion 229 having a cross-section the same as the base, which is not shown, of the wedge element 228. In the latter a first inclined plane 230 is obtained that faces in a direction opposite the second side face 226 of the second support element 223 and defines in relation to the latter an angle H that is significantly less than 90°.

The second portion 215 comprises a further first support element 232 that consists of a further greater branch 232a and a further lesser branch 232b. The further greater branch 232a, which is approximately rectangle-shaped, is integral with a further longitudinal projection 233 that protrudes from the second face 231 of the movable bar 210 and is at right angles to the latter. The further lesser branch 232b is at right angles to the greater branch 232a and is integral with the second face 231. An end portion of the further lesser branch 232b, which is substantially rectangle-shaped, is integral with the connecting plate 216. The further first support element 232 has a further free margin 234 that first runs straight near the connecting plate 216 and then becomes convex and then terminates again straight near the further longitudinal projection 233. A further second support element 235 that is substantially parallelepiped-shaped is simultaneously associated with the further first support element 231, with the second face 231 of the movable bar 210 and with the further longitudinal projection 33. The further second support element 235 has a further chamfered first end face 236, and a further second end face that is not shown and is opposite the further first end face 236, which is integral with the further first support element 232. A further first side face 237 of the further second support element 235, opposite the second face 231 of the movable bar 210, is partially occupied by a further third support element 238, having a cross-section shaped like the further greater branch 232a of the further first support element 232. Two further faces that are not shown of the third support element 238 are respectively integral with the further first support element 232 and with the further longitudinal projection 233. A rectangular plate 239 is integral with the further second support element 235 at a further second side face 240 of the latter, adjacent to the further first side face 237 and opposite the second face 231 of the movable bar 210. The rectangular plate 239 is arranged parallel in relation to the second face 231 of the movable bar 210 and at right angles to the further second side face 240.

Owing to the cursor with which the connecting plate 216 is provided, the first inclined plane element 202 may run along the race 217 in two directions F1 and F2 that are parallel to each other and opposite and parallel to the movable bar 210, in such a way that the wedge element 228 can alternately pass from a closing position A to an opening position B (shown by a broken line), closing position A and opening position B being near opposite ends of the race 217. More precisely, closing position A is maintained through prior-art elastic elements that are not shown such as, for example, a spring that is associated with the cursor of the connecting plate 216. In order to move the wedge element 228 from closing position A to opening position B, it suffices to slightly push the first inclined plane element 202 in direction F1 in such a way that the cursor of the connecting plate 216 traverses the race 217, thus compressing the spring. As soon as the thrust in direction F1 ceases, the spring extends, in turn pushing the first inclined plane element 220 in direction F2, and thus returning the wedge element 228 to closing position A.

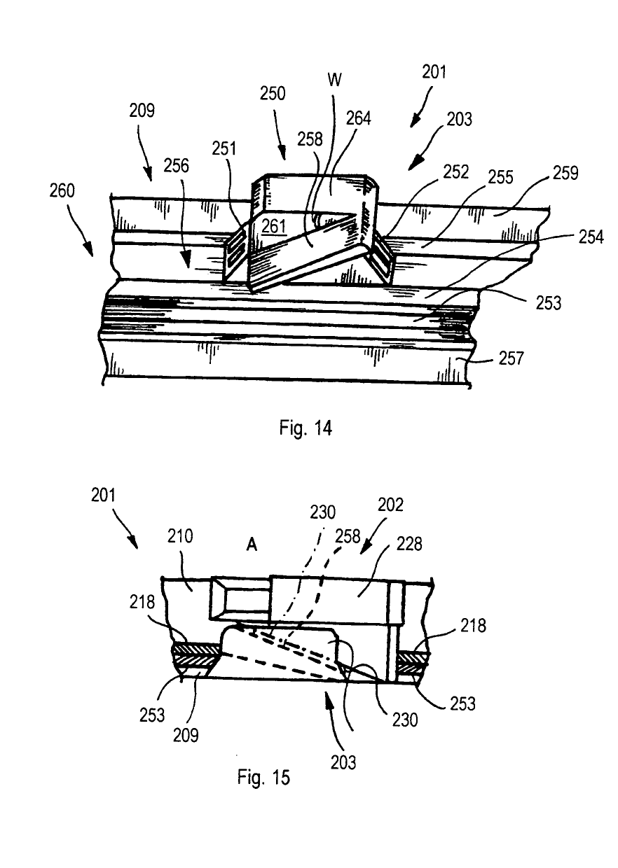

With reference to FIG. 14, the second inclined plane element 203 comprises a body 250 that is substantially parallelepiped-shaped and is associated internally with a seat 256, made in the form of a longitudinal groove and comprised in the second upright 209. The seat 256 is delimited by a first longitudinal element 254 and by a second longitudinal element 255 that are parallel to each other and in turn accommodated in a further seat 260, obtained inside the second upright 209 and delimited by a first wall 257 and by a second wall 259, both parallel to the second upright 209. Between the first wall 257 and the seat 256 a further magnet 253 is placed that extends longitudinally and is arranged parallel to the second upright 209. Between the second wall 259 and the further magnet 253 the seat 256 is interposed to which the body 250 is constrained through a first base portion 251 and a second base portion 252 that are wedge-shaped and are integral with one another. The body 250 furthermore comprises a flat face 264 opposite the first base portion 251 and the second base portion 252 and which runs parallel to the second upright 209. From a portion of the flat face 264 turned to the further magnet 253 and from an adjacent side surface 261 of the body 250 a second inclined plane 258 originates that has the shape of a rectangular lamina and has an approximately triangular longitudinal section. The second inclined plane 258 is arranged to interact in use with the first inclined plane 230 of the first inclined plane element 202 and is arranged in such a way as to define in relation to the flat face 264 a further angle W of the same degree as angle H in relation to the first tilted plane 230.

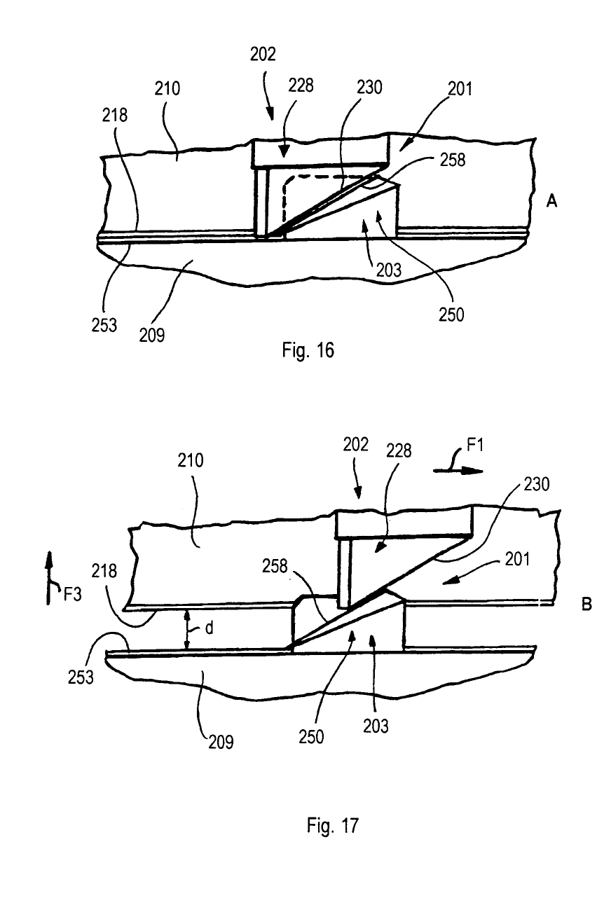

With reference to FIG. 15, when the wedge element 228 is in closing position A, i.e. when the movable bar 210 is placed in contact with the second upright 209 and the windable mosquito-net 212 is completely unwound from the respective shaft, the second inclined plane 258 and the first inclined plane 230 are mutually juxtaposed. In this closing position A, the magnet 218 and the further magnet 253 mate and are thus at a distance that enables mutual attraction, which enables the movable bar 210 and the second upright 209 to be kept fixed to each other. With reference to FIGS. 16 and 17, when a user, who is not shown, pushes lightly in direction F1 on a portion of the first inclined plane element 202, for example on the first support element 219 or on the further first support element 232, the first inclined plane 230 passes from closing position A to opening position B and then slides on the second inclined plane 258, thus distancing the movable bar 210 from the second upright 209. This means that the magnet 218 is distanced from the further magnet 253 by a distance d that is such as to overcome the mutual attraction between the latter. As a result, the movable bar 210 is free to passively follow the mosquito-net 212 during rewinding of the latter caused by the return devices with which the corresponding shaft is provided and once the pressure exerted by the user terminates, the first inclined plane element 202 automatically returns to closing position A.

In this way, the user can release the movable bar 210 of the mosquito-net 212 and open the latter simply by exerting slight pressure on the device 201. In order to again close the mosquito-net 212, the user has to slide the movable bar 210 until the magnet 218 and the further magnet 253 mate, which can thus attract each other and keep the movable bar 210 connected to the second upright 209.

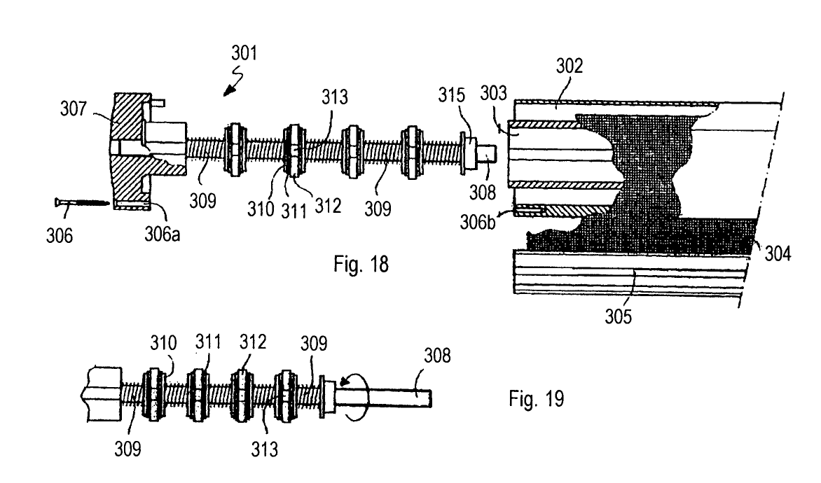

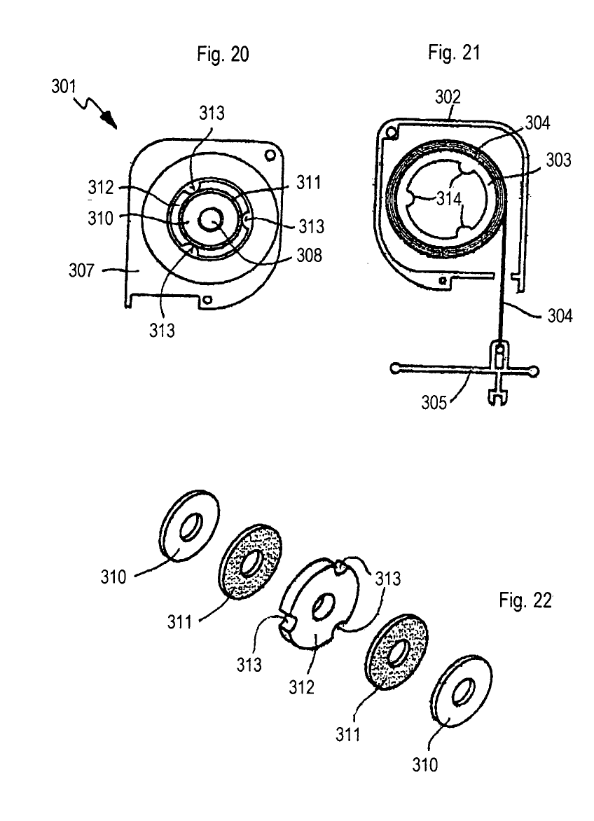

With reference to FIGS. 18 to 22, 301 altogether indicates a braking device for a flexible-screen apparatus such as for example a windable mosquito-net.

A windable mosquito-net comprises two side guides (not shown) and a transverse profiled element 302 connecting the two guides and arranged in such a way as to be opposite a windowsill or threshold of a French window (not shown). Inside the transverse profiled element 302 a rotatable roller 303 is rotatably fitted on which there is wound an anti-insect net 304 or mosquito-net. At the end of the latter there is fixed a batten 305 that prevents the mosquito-net 304 from completely entering within the profiled element 302 through the action of a spring (not shown) that acts by forcing the roller 303 to rotate. The braking device 301 is fitted frontally in the profiled element 302 and locked there by means of a screw 30 that is inserted into a hole 306a of a head 307 of the braking device 301, engaging in a threaded channel 306b of the transverse profiled element 302. A stem 308, having a threaded end, is connected to the head 307.

On the stem there are mounted, concentrically in relation to the latter, springs 309 that are separated from one another by means of a set of serially fitted organs.

Each set consists of two external rosette washers 310 and of two intermediate discs 311, the rosette washers 310 and the discs 311 being symmetrically arranged. Between the two discs 311 there is interposed a flat washer 312 of greater diameter than that of the other organs.

Each flat washer 312 has grooves 313 obtained along its perimeter and such as to enable the flat washer 312 to rigidly couple with the roller 303, which has reinforcements 14 inside itself: when the braking device 301 is inserted in the profiled element 302, the reinforcements 314 engage the grooves 313, thereby making the roller 303 and the flat washers 312 integral with one another.

Near the threaded end of the stem 309, a threaded nut 315 is fitted that is rigidly adjustable in different positions of the stem 308, thereby keeping the springs 309 more or less compressed, according to its position.

The rosette washers 310 are substantially integral with the stem 308 inasmuch as the springs 309, which are fixed, rest on the surface of the rosette washers 310, thereby keeping the latter fixed.

The disc 311 is made of material with high surface friction: for example, discs 311 in leather or hide or synthetic material and also particular types of cloths (such as felt) can be used.

Operation of the invention is intuitive, by positioning the mosquito-net 304 in such a way that the batten 305 rests on a window sill or on a threshold of a French door (not shown), correct protection against the entry of insects is obtained. When the passage has to be opened the batten 305 is released from a locking organ (not shown) that is current near the sill or threshold and the roller 303 is allowed to rewind the mosquito-net 304.

The upward stroke, although the springs that act on the roller 303 are extremely strong, is slowed because the roller 303 is coupled with the flat washers 312. The flat washers 312 cannot move freely inasmuch as the latter are braked by the discs 11, which in turn are pressed by the rosette washers 310 through the action of the springs 309 against the side faces of each flat washer 312.

As the friction depends on the friction coefficient of the materials used and on the pressure exerted, once the material has been selected (having a specific friction coefficient) with which to make the discs 311 it is sufficient to tighten the nut 315 on the stem 308 to varying degrees in order to vary pressure at will and therefore to vary the upstroke speed of the mosquito-net 304 and of the respective batten 305.

A flexible-screen apparatus comprising one or more of the above embodiments of the invention may be furthermore provided with a box device, intended to accommodate a respective flexible-screen element, for example a windable mosquito-net, when the latter is not in use. The box-device can be made in such a way as to have one or more of the constructional and functional features defined in Italian utility model B097U000065 and in the derivative European patent EP 0870896.

1. Locking device, in particular a locking device for a mosquito-net upright, comprising a plinth element suitable for interacting between an end of an upright and a building opening, a cursor element engaging in a groove of said upright and suitable for regulating a preliminary position of said plinth element, a cam element suitable for regulating a final position of said plinth element, wherein said cursor element is provided inside itself with a coupling seat suitable for receiving said cam element.

2. Locking device according to claim 1, wherein said plinth element comprise first side walls suitable for slidingly receiving second side walls of said upright and provided with coupling grooves inside said plinth element and arranged along a longitudinal axis of said upright.

3. Locking device according to claim 2, wherein from a support base of said plinth element and between said coupling grooves an appendage protrudes along said longitudinal axis, which appendage is suitable for engaging in said coupling seat.

4. Locking device according to claim 3, wherein said cursor element comprises side portions between which said appendage is accommodated and configured in such a way as to be accommodated in said coupling grooves.

5. Locking device according to claim 3, or 4, wherein said appendage is provided at its top with a first concave surface turned to said end of an upright.

6. Locking device according to claim 5, wherein said coupling seat is arranged on a side of said cursor element opposite a further side interacting with said building opening and is delimited by a second concave surface facing said first concave surface.

7. Locking device according to claim 6, wherein said cam element is provided with a coupling profile having a substantially elliptic shape suitable for interacting with said first concave surface and with said second concave surface.

8. Locking device according to claim 7, wherein said coupling profile is positionable from a configuration associated with said preliminary position, wherein the distance between said plinth element and said cursor element is minimal, to a further configuration associated with said final position, wherein the distance between said plinth element and said cursor element is maximum.

9. Guide device equipped with a longitudinal cavity having an edge arranged at a certain distance from an intended support plane, said longitudinal cavity being suitable for guiding the sliding of a flexible-screen element arranged to be coupled with a building opening, wherein a surface element is provided that progressively declines towards said intended support surface moving away from said longitudinal cavity.

10. Guide device equipped with a longitudinal cavity having an edge arranged at a certain distance from an intended support surface, said longitudinal cavity being suitable for guiding the sliding of a flexible-screen element arranged to be coupled with a building opening, wherein said longitudinal cavity comprises a base wall element arranged substantially in contact with said intended support plane.

11. Guide device suitable for guiding the sliding of a flexible-screen element, wherein a tensioning device is furthermore arranged for tensioning said flexible-screen elements when said flexible-screen element interacts with said guide device.

12. Apparatus, comprising a bar device suitable for dragging a flexible-screen element of a building opening and having ends that can be engaged in opposed guides arranged at a certain mutual distance, wherein one of said ends is provided with a distance compensating element configured in such a way as to enable the length of said bar device to be varied according to said distance.

13. Device arranged for being associated with a frame for a windable screen element and configured in such a way as to enable a movable portion of said frame to move away from a fixed portion of said frame.

14. Braking device for an apparatus equipped with a flexible-screen element comprising two side guides and a transverse profiled element within which a roller is present that is forced to rotate by a spring, on which roller said flexible-screen element is wound, said flexible-screen element having a protruding end fixed on a batten, and furthermore comprising a stem on which a flat washer is fitted that is shapingly coupled with an inner surface of said roller, said flat washer having at least one face in contact with a disc in material having a high surface-friction coefficient, said disc being rigidly coupled with a fixed part of said device.
